(19) United States
(12) Patent Application Publication
(10) Pub. No.: US 2005/0196675 A1
(43) Pub. Date: Sep. 8, 2005

(54) Rechargeable lithium battery containing ion-irradiated carbonaceous material and production thereof

(76) Inventors: Tomihiro Hashizume, Hatoyama (JP); Masahiko Ichimura, Sendai (JP); Masahiro Kasai, Mito (JP); Rikizo Hatakeyama, Sendai (JP); Yoshiyuki Kawazoe, Sendai (JP)

Correspondence Address: REED SMITH LLP, Suite 1400, 3110 Fairview Park Drive, Falls Church, VA, 22042, US

(21) Appl. No.: 10/928,252

(22) Filed: Aug. 30, 2004

(30) Foreign Application Priority Data
Mar. 5, 2004 (JP) 2004-061897

(51) Int. Cl. H01M 4/58; B05D 5/12; C01B 31/30

(52) U.S. Cl. 429/231.4; 427/113; 427/126.1; 423/439

(57) ABSTRACT

A rechargeable lithium battery includes an anode doped with lithium ions in an amount corresponding to the irreversible capacity. The anode is produced by applying lithium ions to an anodic active carbonaceous material. The anode may be produced by applying a slurry of the anodic active material composition containing a carbonaceous material to an anodic collector, drying and compression-molding the resulting article, and applying lithium ions to the molded article. Alternatively, the lithium-doped anode may be produced by applying lithium ions in the production of a carbonaceous material to yield a carbonaceous material containing lithium ions, and mixing the same with a carbonaceous material containing no lithium ions. The resulting rechargeable lithium battery using, for example, amorphous carbon as an anodic active material and a lithium transition metal compound as a cathodic active material shows a reduced irreversible capacity.

### CLAIM OF PRIORITY

The present application claims priority from Japanese application JP 2004-61897 filed on Mar. 5, 2004, the content of which is hereby incorporated by reference into this application.

### FIELD OF THE INVENTION

The present invention relates to an anodic material for a rechargeable lithium battery and to a rechargeable lithium battery using the anodic material.

### BACKGROUND OF THE INVENTION

With the proliferation of video cameras, notebook computers and mobile phones, demands have been made to miniaturize, to reduce the weight of and to increase the capacity of batteries serving as their power sources. Rechargeable lithium batteries have received attention as promising materials to satisfy these requirements. Such rechargeable lithium batteries comprise a carbonaceous material as an anodic active material with which lithium can be doped and dedoped, and a lithium transition metal compound as a cathodic active material. Most of anodic active materials of commercially available rechargeable lithium batteries are of graphite. Such rechargeable lithium batteries using graphite as an anodic active material have a theoretical upper limit of capacity of 372 mAh/g and cannot have a higher capacity. In contrast, rechargeable lithium batteries using amorphous carbon as an anodic active material have a possible theoretical capacity of 400 to 800 mAh/g and can thereby have a higher capacity than conventional rechargeable lithium batteries using graphite.

The reversible capacity and irreversible capacity are ones of key features of rechargeable batteries and are defined as follows. Namely, a rechargeable battery having a cathode (positive electrode) and an anode (negative electrode) is initially charged and then initially discharged. In this procedure, the reversible capacity is defined as the quantity of electricity that can be discharged in the initial discharge, and the irreversible capacity is defined as the difference between the quantity of electricity charged in the initial charge and the reversible capacity. FIG. 1 shows an example of initial-charge and initial-discharge properties of a rechargeable lithium battery, in which the charge-discharge potential is plotted against the charge-discharge capacity, and shows an initial charge curve, initial discharge curve and irreversible capacity. By minimizing the irreversible capacity, rechargeable batteries can be reduced in size and weight and have a higher capacity. Conventionally, a carbonaceous material as an anodic active material is doped with lithium in initial charge, but part of such doped lithium is not dedoped (removed) and remains in the anodic active material. This remained lithium is considered to cause the irreversible capacity.

Such an anodic active material containing amorphous carbon has a large theoretical capacity but shows a large irreversible capacity. Namely, it shows a very large irreversible capacity up to about 20% of the initial charge capacity, whereas graphite shows a small irreversible capacity of several percent or less of the initial charge capacity.

As possible solutions to this problem, the following several techniques have been proposed, but they are still insufficient in, for example, their complicated production process, technical difficulties and cost efficiency in production processes and resulting products. For example, Japanese Unexamined Patent Application Publication No. 05-234621 discloses a production method of a rechargeable lithium battery by using a lithium multiple oxide to which lithium powder has been applied as a cathodic active material or a carbonaceous electrode to which lithium powder has been applied as an anodic active material. The production method requires extra processes of, for example, immersing the electrode in a dispersion of lithium powder in hexane, drying the immersed electrode and rolling the dried electrode. It uses highly chemically active lithium powder and thereby requires facilities for safety.

Japanese Unexamined Patent Application Publication No. 07-35330 discloses a method of preparing an anode using a carbonaceous material as an anodic active material and previously doping the anodic active material with lithium in an amount corresponding to the irreversible capacity. This technique requires an extra process of preliminarily charging the prepared anode using a lithium electrode as a counter electrode in an electrolyte, thus inviting increased energy consumption and increased cost for previous charge.

Japanese Unexamined Patent Application Publication No. 08-55635 discloses a rechargeable battery, in which a carbonaceous material as an anodic active material is doped with lithium from a cathodic lithium-containing metal oxide, and a cathode is doped with lithium from metallic lithium placed in the battery and connected to the cathode, after assembling the battery. This technique requires two-step initial charge procedures including a first charge for doping the anodic active carbonaceous material from the cathodic lithium-containing metal oxide, and a second charge for doping the cathode from metallic lithium. The lithium stands in a highly chemically active metallic state until the initial charge procedure, thus inviting safety problems. In addition, the portion where the metallic lithium is placed becomes a cavity after the metallic lithium dissolves, thus inviting a decreased capacity per unit volume of the battery.

Japanese Unexamined Patent Application Publication No. 09-83181 discloses a rechargeable nonaqueous-electrolyte battery containing a nonaqueous electrolyte which further contains lithium in an amount corresponding to the irreversible capacity and is prepared by adding an organolithium compound thereto. However, the rechargeable battery must be initially charged while the top of the battery case is opened. In addition, the battery may invite an increased inside pressure after sealing the case, because a gas is formed due to the decomposition of the organolithium compound.

Japanese Unexamined Patent Application Publication No. 10-23259 discloses a rechargeable lithium battery containing a cathode doped with lithium in an amount corresponding to the irreversible capacity by making a short circuit in metallic lithium arranged in the battery and a cathode. This technique requires an extra charge procedure of doping the cathode with lithium from metallic lithium prior to the initial charge. The lithium stands in a highly chemically active metallic state until the charge procedure, thus inviting safety problems. In addition, the battery may invite an increased inside pressure after sealing the case, because a gas is formed due to the decomposition of the organolithium compound.

Japanese Unexamined Patent Application Publication No. 11-88705 discloses a rechargeable lithium battery prepared by previously mixing an anodic active carbonaceous material with a lithium-containing substance including an alloy such as LiAl or a lithium nitride such as Li₃₋ₓCoₓ to thereby compensate for decreases in capacity in an amount corresponding to the irreversible capacity. However, the rechargeable lithium battery comprising such a lithium-containing compound has a decreased energy density, because the lithium-containing compound has an increased potential with respect to Li or Li⁺ ion.

Japanese Unexamined Patent Application Publication No. 2002-373657 discloses a rechargeable battery and a production method thereof, using an anodic active carbonaceous material which is prepared by mechanically alloying lithium and graphite and is thereby doped with lithium in an amount corresponding to the irreversible capacity. However, it requires a relatively long time to mechanically alloy the material, and lithium contained in the resulting graphite material prepared by mechanical alloying will react with moisture in an atmosphere, thus the temperature and atmosphere should be controlled and extra measures for safety must be taken in the assembly of the battery.

### SUMMARY OF THE INVENTION

Accordingly, an object of the present invention is to provide a rechargeable lithium battery using a lithium transition metal compound as a cathodic active material and amorphous carbon that can be doped and dedoped with lithium and has a large theoretical capacity as an anodic active material, which rechargeable lithium battery shows a reduced irreversible capacity, can thereby be reduced in size and weight and have a higher capacity, be easily produced and initially charged and is advantageous in economical efficiency and safety. Another object of the present invention is to provide a method for easily and economically efficiently producing the rechargeable lithium battery with safety.

Specifically, the present invention provides a method for producing an anode for a rechargeable lithium battery, by applying lithium ions to a carbonaceous material to thereby yield an anodic active material doped with lithium ions in an amount corresponding to an irreversible capacity. The lithium ions are accelerated by the voltage applied to an acceleration electrode, applied to the carbonaceous material and directly taken into the anodic active carbonaceous material as lithium ions. The lithium ions may be applied to the carbonaceous material after applying a slurry of an anodic active carbonaceous material composition to an anodic collector; drying the slurry composition; and compression-molding the resulting article. An anode doped with lithium ions in an amount corresponding to the irreversible capacity may be produced by applying lithium ions to a carbonaceous material in its production to thereby yield a carbonaceous material containing lithium ions; mixing the carbonaceous material containing lithium ions with a carbonaceous material containing no lithium ions to yield an anodic active carbonaceous material doped with lithium ions in an amount corresponding to the irreversible capacity; and forming the anode doped with lithium ions in an amount corresponding to an irreversible capacity using the lithium-doped anodic active material.

In addition, the present invention provides a rechargeable lithium battery having an anode produced by any of the above-mentioned methods.

The present invention can provide a rechargeable lithium battery using a lithium transition metal compound as a cathodic active material and amorphous carbon that can be doped and dedoped with lithium and has a large theoretical capacity as an anodic active material. The rechargeable lithium battery shows a reduced irreversible capacity, can thereby be reduced in size and weight, have a higher capacity, be easily produced and initially charged and is advantageous in economical efficiency and safety in its producing method and products.

Further objects, features and advantages of the present invention will become apparent from the following description of the preferred embodiments with reference to the attached drawings.

### BRIEF DESCRIPTION OF THE DRAWINGS

FIG. 1 illustrates an example of initial-charge and initial-discharge properties of a rechargeable lithium battery, in which the charge-discharge potential is plotted against the charge-discharge capacity;

FIG. 2 illustrates a method for doping an anode with lithium ions in an amount corresponding to the irreversible capacity after applying a slurry of an anodic active carbonaceous material composition to an anodic collector, drying the slurry, and compression-molding the resulting article, according to First Embodiment;

FIG. 3 is a diagram showing an example of the configuration of a rechargeable lithium battery according to First Embodiment;

FIG. 4 illustrates an example of initial-charge and initial-discharge properties of a rechargeable lithium battery having an anode doped with lithium ions in an amount corresponding to the irreversible capacity according to First Embodiment, in which the charge-discharge potential is plotted against the charge-discharge capacity;

FIG. 5 illustrates an apparatus used in Second Embodiment, in which a carbonaceous material containing lithium ions is produced by applying lithium ions to a carbonaceous material in its production;

FIG. 6 illustrates an apparatus used in Third Embodiment, in which a carbonaceous material containing lithium ions is produced by applying lithium ions to a carbonaceous material in its production; and

FIG. 7 is a sectional view of a dielectric-associated electrode 85 for high-pressure plasma discharge used in the apparatus of FIG. 6.

### DESCRIPTION OF THE PREFERRED EMBODIMENTS

The present invention will be illustrated in further detail with reference to several embodiments and attached drawings.

### First Embodiment

In First Embodiment, the production method and configuration of the rechargeable lithium battery according to the present invention will be illustrated. As the anodic active material, a carbonaceous material that can be doped and dedoped with lithium is used. Such a carbonaceous material is prepared, for example, by carbonizing an organic raw material such as pitch, tar, cokes, woody materials, furan resins, phenol resins, cellulose, methane or propane at high temperatures. However, any other carbonaceous materials used in such rechargeable batteries can also be used. Each of these carbonaceous materials can be used alone or in combination.

The anodic active material is mixed with a binder such as poly(vinylidene fluoride) to form an anodic active carbonaceous material composition and is then dispersed in a medium such as N-methyl-2-pyrrolidone to yield a slurry thereof. The slurry of the anodic active carbonaceous material composition is applied to both sides of an anodic collector such as a band-shaped copper foil, is dried and is rolled to yield an anode. The binder includes, but is not limited to, fluorine-containing resins such as poly(vinylidene fluoride) and fluorocarbon rubber; as well as polypropylenes, polyethylenes and cellulose ethers. The medium for dispersing the composition includes, but is not limited to, N-methyl-2-pyrrolidone and dimethylformamide. The material for the anodic collector includes, but is not limited to, carbon, platinum, copper, nickel, stainless steel and aluminum.

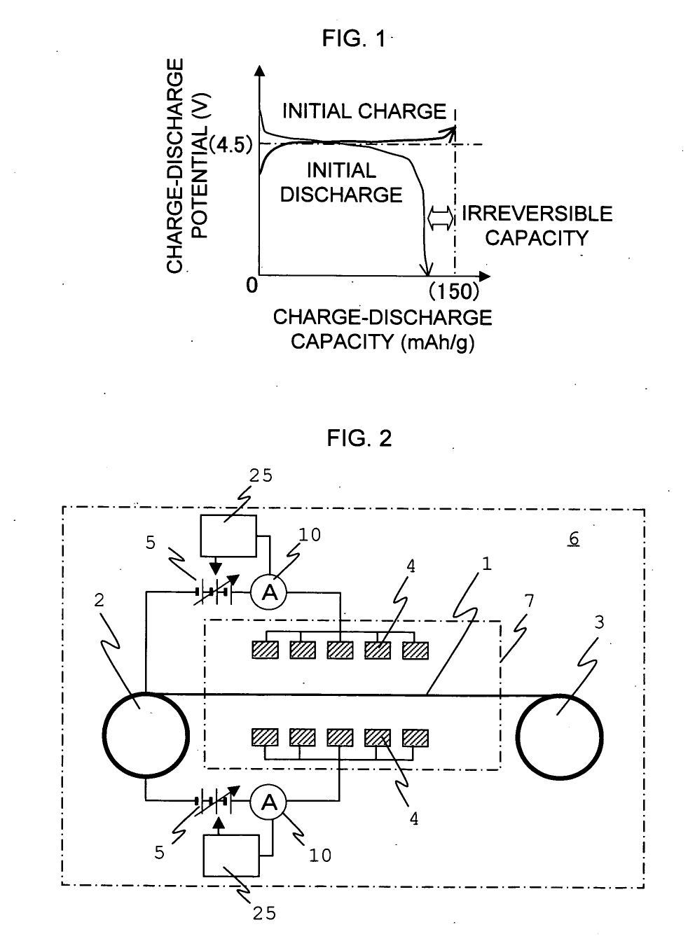

FIG. 2 illustrates a method for doping an anode with lithium ions in an amount corresponding to the irreversible capacity. The anode herein has been formed by applying a slurry of an anodic active carbonaceous material composition to an anodic collector, drying the slurry, and compression-molding the resulting article, according to First Embodiment. An anodic material 1 is prepared by applying a slurry of anodic active carbonaceous material composition to an anodic collector, drying and compression-molding the same. The anodic material 1 has been wound around an unwinding roller 2, is pushed out with the rotation of the unwinding roller 2 and is wound up with the rotation of a wind-up roller 3. Lithium ion sources 4 are arranged on both sides of the anodic material 1 so as to face the anodic material 1. An acceleration power source 5 applies an acceleration voltage to the lithium ion sources 4. The acceleration voltage accelerates lithium ions emitted from the lithium ion sources 4, are applied to the anodic material 1 as high-energy ion beams and are contained in the anodic material 1 as lithium ions. A current detector 10 detects an irradiation current supplied by the acceleration power source 5. A current control circuit 25 detects the difference between an actual output measured by the current detector 10 and a set value, controls the voltage of the acceleration power source 5 and vary the irradiation current of lithium ions to thereby control the irradiation rate of lithium ions. The quantity of lithium ions corresponding to the irreversible capacity to be doped to the anodic active material can be previously set by determining the initial-charge properties and initial-discharge properties, by plotting the charge-discharge potential against the charge-discharge capacity, as shown in FIG. 1.

The atmosphere in the application of lithium ions emitted from the lithium ion sources 4 to the anodic material 1 can be vacuum or an atmosphere of electron-lithium ion plasma or anion-lithium ion plasma, as shown by Hatakeyama, R. in “Butsuri” (the bulletin (in Japanese) of the Physical Society of Japan), 57, 11(2002), p. 804. In any case, the anodic material 1, the unwinding roller 2, the wind-up roller 3, the lithium ion sources 4, the acceleration power source 5 and other components are arranged in a housing 6. As the housing 6, a regular plasma apparatus can be used.

In the configuration of FIG. 2, the lithium ion sources 4 are placed in a differential pumping casing 7. In the casing 7, the lithium ions can be applied under more precisely controlled conditions than in the housing 6 which further housing other components such as the unwind roller 2, the take-up roller 3, the lithium ion sources 4 and the acceleration power source 5. Thus, the slurry of the anodic active carbonaceous material composition can be applied to the anodic collector, dried and compression-molded under precisely controlled conditions, and the anodic material 1 can be continuously unwound. Thus, products with stable quality can be produced at low cost.

According to the First Embodiment, for example, a total ion current of lithium ions emitted from the lithium ion sources 4 arranged five each in two rows in parallel is 11 A so as to apply lithium ions in an amount corresponding to the irreversible capacity of 10% of a charge-discharge capacity of 150 mAh/g when the anodic material 1 has a width of 10 cm, a thickness of 1 mm in one side, and is unwound at a rate of 1 cm/s.

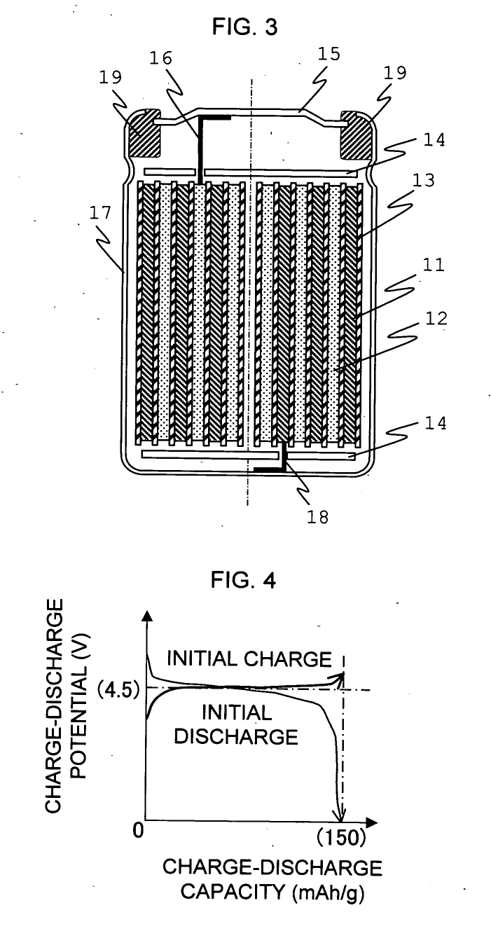

FIG. 3 is an example of the configuration of a rechargeable lithium battery produced according to First Embodiment. The rechargeable lithium battery according to the present invention uses an anode 11 comprising an anodic active material doped with lithium ions in an amount corresponding to the irreversible capacity. Any configuration can be employed regarding other components than the anodic material. For example, the configuration of a rechargeable lithium battery disclosed in Japanese Unexamined Patent Application Publication No. 2002-80076 can be employed.

More specifically, a strip anode 11 and a strip cathode 12 are laminated with the interposition of a separator 13, and the resulting laminate is spirally coiled to form a spiral electrode. After inserting an electric insulating sheet 14, the spiral electrode is placed in a battery can 17. In this procedure, the anode 11 and the battery can 17 are brought into electric contact with each other using an anode lead 18 for current collection in the anode. An electrolyte is charged into the battery can 17, the insulating plate 14 is inserted, and the can 17 is sealed with a positive terminal 15 insulated by a packing 19. In this procedure, the cathode 12 and the positive terminal 15 are brought into electrical contact with each other using a cathode lead 16 for current collection in the cathode.

The cathodic active material includes, but is not limited to, LiₓMn₂O₄ wherein X is from 0.05 to 2.0, LiₓCoO₂ wherein X is from 0.05 to 1.10, and LiₓNiO₂ wherein X is from 0.05 to 1.10. Each of such cathodic active materials can be used alone or in combination. The cathodic active material is mixed with a conductor and a binder according to necessity to yield a cathodic active material composition, and is dispersed in a medium to yield a slurry thereof. The slurry of cathodic active material composition is applied to both sides of the cathodic collector, dried and compression-molded with a roller to yield the cathode 12.

The conductor includes, but is not limited to, carbon black, acetylene black and graphite. The binder includes, but is not limited to, fluorine-containing resins such as poly(vinylidene fluoride) and fluorocarbon rubber; as well as polypropylenes, polyethylenes and cellulose ethers. The medium for dispersing the composition includes, but is not limited to, N-methyl-2-pyrrolidone and dimethylformamide. The material for the anodic and cathodic collector includes, but is not limited to, carbon, platinum, copper, nickel, stainless steel and aluminum.

The electrolyte includes, but is not limited to, nonaqueous electrolytic solutions prepared by dissolving a lithium salt electrolyte such as LiClO₂, LiAsF₆, LiPF₆, LiBF₄, LiCl or LiBr in an organic solvent such as propylene carbonate, ethylene carbonate, 1,2-dimethoxyethane, tetrahydrofuran or sulfolane.

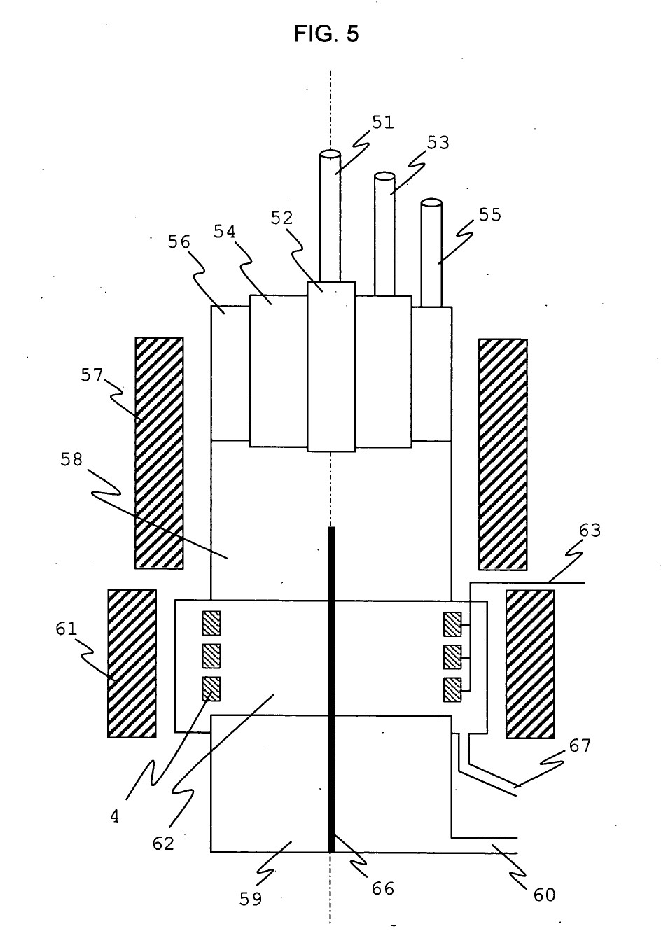

FIG. 4 illustrates an example of initial-charge and initial-discharge properties of a rechargeable lithium battery having an anode doped with lithium ions in an amount corresponding to the irreversible capacity according to First Embodiment, in which the charge-discharge potential is plotted against the charge-discharge capacity. FIG. 4 indicates that the rechargeable lithium battery shows substantially identical charge-discharge capacities at the end points in the initial-charge curve and initial-discharge curve, thus has a decreased irreversible capacity and can thereby be reduced in size and weight and have a higher capacity.

### Second Embodiment

According to Second Embodiment, the rechargeable lithium battery of the present invention is produced by the method comprising the steps of applying lithium ions to a carbonaceous material in its production to thereby yield a carbonaceous material containing lithium ions; mixing the carbonaceous material containing lithium ions with a carbonaceous material containing no lithium ions to yield an anodic active carbonaceous material doped with lithium ions in an amount corresponding to the irreversible capacity; and forming an anode doped with lithium ions in an amount corresponding to an irreversible capacity using the lithium-doped anodic active material.

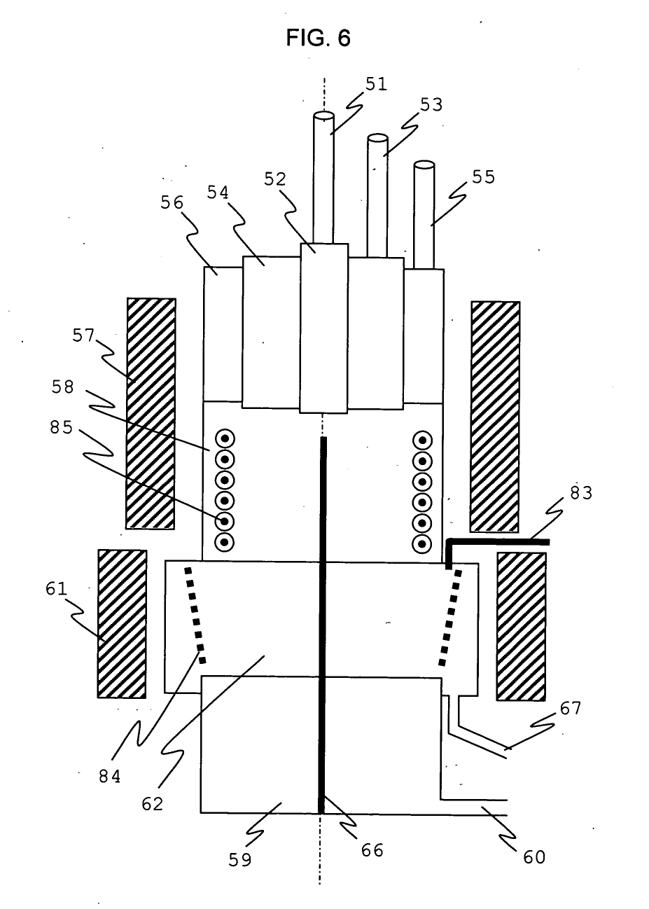

FIG. 5 illustrates an apparatus used in Second Embodiment, in which a carbonaceous material containing lithium ions is produced by applying lithium ions to a carbonaceous material in its production.

To produce a vapor-deposition carbonaceous material efficiently using the apparatus as shown in FIG. 5, a material gas and a carrier gas are generally supplied under a relatively high pressure. (e.g., 10⁻⁵ Pa to 400 Pa) than a regular vacuum. According to Second Embodiment, lithium ions are formed and accelerated under a relatively high pressure and then applied in the production of the carbonaceous material.

With reference to FIG. 5, a material gas supply tube 51 supplies a gas of carbon compound such as methane, ethane or benzene. A material gas supply nozzle 52 works to inject the material gas supplied from the material gas supply tube 51 into a tubular reactor 58 (e.g., Japanese Unexamined Patent Application Publication No. 08-301699). The tubular reactor 58 is heated by an electric furnace 57 surrounding the same. First and second carrier gas supply tubes 53 and 55 supply a carrier gas. A first carrier gas supply nozzle 54 or a second carrier gas supply nozzle 56 injects the supplied carrier gas into the tubular reactor 58. By supplying a gas of organic transition metal compound such as ferrocene from the first carrier gas supply tube 53 via the first carrier gas supply nozzle 54 into the tubular reactor 58, the organic transition metal compound is decomposed in a gas phase to form a transition metal catalyst to thereby accelerate a chemical reaction for the formation of the carbonaceous material. Further, by supplying a gas containing fine particles of a transition metal from the second carrier gas supply tube 55 via the carrier gas supply nozzle 56 into the tubular reactor 58, the fine particles of transition metal react with the transition metal catalyst to thereby accelerate the chemical reaction for the formation of the carbonaceous material.

The carbonaceous material formed in the tubular reactor 58 moves downstream and flows into a tubular lithium-ion irradiator 62. The tubular lithium-ion irradiator 62 is heated by an electric furnace 61 surrounding the same. The tubular lithium-ion irradiator 62 comprises an auxiliary electrode 66 at its center part and the lithium ion sources 4 described in First Embodiment which surround the auxiliary electrode 66 in the inner periphery of the tubular lithium-ion irradiator 62. The acceleration power source 5 having the current control circuit 15 described in First Embodiment applies a voltage between the lithium-ion sources 4 and the auxiliary electrode 66 to thereby apply lithium ions to the carbonaceous material. The content of lithium ions in the resulting carbonaceous material, namely, the ratio of a carbonaceous material containing lithium ions to a carbonaceous material containing no lithium ions can be controlled by controlling the irradiation current, as in First Embodiment.

The carbonaceous material containing lithium ions is recovered in a collection case 59 arranged downstream from the tubular lithium-ion irradiator 62.

Exhaust tubes 67 and 60 arranged downstream from the tubular lithium-ion irradiator 62 and the collection case 59 work to accelerate the flow of the gas injected into the 58 and to exhaust extra gas.

According to Second Embodiment, a carbonaceous material containing lithium ions can be produced by applying lithium ions in the production of the carbonaceous material. By mixing the carbonaceous material containing lithium ions with a carbonaceous material containing no lithium ions, a carbonaceous material containing lithium ions in an amount corresponding to the irreversible capacity can be produced. The resulting carbonaceous material contributes to production a rechargeable lithium battery showing a reduced irreversible capacity.

### Third Embodiment

According to Third Embodiment, a carbonaceous material containing lithium ions is produced by applying lithium ions in the production of the carbonaceous material as in Second Embodiment, except that the apparatus used herein has different configurations of the tubular reactor 58 and the tubular lithium-ion irradiator 62.

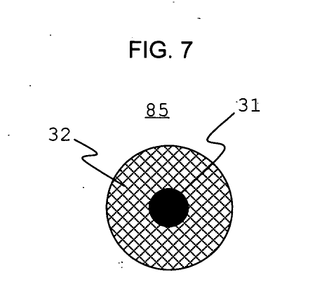

FIG. 6 illustrates an apparatus used in Third Embodiment, in which a carbonaceous material containing lithium ions is produced by applying lithium ions to a carbonaceous material in its production. FIG. 7 is a sectional view of a dielectric-associated electrode 85 for high-pressure plasma discharge used in the apparatus of FIG. 6.

The contrast between FIG. 6 and FIG. 5 shows that the tubular reactor 58 according to Third Embodiment comprises an auxiliary electrode 66 at its center part and a dielectric-associated electrode 85 helically arranged in the inner periphery of the tubular reactor 58. In addition, a tungsten coil 84 is arranged, instead of the lithium-ion sources 4, in the inner periphery of the tubular lithium-ion irradiator 62, and a lithium supply tube 83 is arranged to supply vaporized lithium, fine particles of lithium, and/or a lithium multiple oxide such as lithium dichromate to the tubular lithium-ion irradiator 62. An appropriate voltage of, for example, about 500 V is applied between the tungsten coil 84 and the auxiliary electrode 66. Other configurations are the same as Second Embodiment.

The dielectric-associated electrode 85 comprises an electrode 31 at its center part and a dielectric 32 which surrounds the electrode 31 and constitutes a coil. By arranging the auxiliary electrode 66 at the center part of the coil and applying a voltage at a certain level or higher, high-pressure plasma discharge occurs (e.g., Roth J. R., Industrial Plasma Engineering Volume 2 Applications to Nonthermal Plasma Processing, Institute of Physics Publishing, 2001, pages 37-73).

According to Third Embodiment, the material gas supply tube 51 and the material gas supply nozzle 52 supply a gas of carbon compound such as methane, ethane or benzene as in Second Embodiment. The first carrier gas supply tube 53 and firs carrier gas supply nozzle 54, and the second carrier gas supply tube 55 and second carrier gas supply nozzle 56 supply a carrier gas. By supplying a gas of organic transition metal compound such as ferrocene from the first carrier gas supply tube 53 via the first carrier gas supply nozzle 54 into the tubular reactor 58, the organic transition metal compound is decomposed in a gas phase to form a transition metal catalyst to thereby accelerate a chemical reaction for the formation of the carbonaceous material. Further, by supplying a gas containing fine particles of a transition metal from the second carrier gas supply tube 55 via the carrier gas supply nozzle 56 into the tubular reactor 58, the fine particles of transition metal reacts with the transition metal catalyst to thereby accelerate the chemical reaction for the formation of the carbonaceous material.

According to Third Embodiment, the chemical reaction for the formation of the carbonaceous material can be further accelerated by the high-pressure plasma discharge formed between the dielectric-associated electrode 85 and the auxiliary electrode 66. In this procedure, neutralized electrons are also formed by the action of the high-pressure plasma discharge. The tubular reactor 58 is heated by the electric furnace 57 surrounding the same, as in First Embodiment.

The carbonaceous material formed in the tubular reactor 58 moves downstream and flows into the tubular lithium-ion irradiator 62. The neutralized electrons formed by the action of the high-pressure plasma discharge also flow downstream. Vaporized lithium, fine particles of lithium, and/or a lithium multiple oxide such as lithium dichromate is supplied from the lithium supply tube 83 to the tungsten coil 84 heated by the electric furnace 61. For example, the vaporized lithium collides against the tungsten coil 84, becomes lithium ions and moves toward the auxiliary electrode 66 at the center part. In this process, the carbonaceous material moves downstream from the tubular reactor 58 takes lithium ions therein. According to Third Embodiment, the neutralized electrons formed by the action of the chemical reaction for the formation of carbonaceous material also work to accelerate the ionization of lithium, and thereby the tungsten coil 84 may not be necessarily heated to a very high temperature. The content of lithium ions in the resulting carbonaceous material, namely, the ratio of a carbonaceous material containing lithium ions to a carbonaceous material containing no lithium ions can be controlled by controlling the temperature of the tungsten coil 84, the voltage applied to the auxiliary electrode 66 and the amount of gas supplied from the lithium supply tube 83.

The carbonaceous material containing lithium ions is recovered in a collection case 59 arranged downstream from the tubular lithium-ion irradiator 62.

Exhaust tubes 67 and 60 arranged downstream from the tubular lithium-ion irradiator 62 and the collection case 59 work to accelerate the flow of the gas injected into the tubular reactor 58 and to exhaust extra gas.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

The reference numerals in drawings are as follows:

1: An anodic material, 2: unwinding roller, 3: wind-up roller, 4: lithium ion sources, 5: acceleration power source, 6: housing, 7: casing, 10: current detector, 11: strip anode, 12: strip cathode, 13: separator, 14: electric insulating sheet, 15: cathode terminal, 16: cathode lead, 17: battery can, 18: anode lead, 19: packing, 25: current control circuit, 31: electrode, 32: dielectric, 51: material gas supply tube, 52: material gas supply nozzle, 53: first carrier gas supply tube, 54: first carrier gas supply nozzle, 55: second carrier gas supply tube, 56: second carrier gas supply nozzle, 57 and 61: electric furnace, 58: tubular reactor, 59: collection case, 60 and 67: exhaust tube, 62: tubular lithium-ion irradiator, 83: lithium supply tube, 85: dielectric-associated electrode, 66: auxiliary electrode.

1. A method for producing an anode for a rechargeable lithium battery, the method comprising the step of applying lithium ions to a carbonaceous material to thereby yield an anodic active carbonaceous material doped with lithium ions in an amount corresponding to an irreversible capacity.

2. The method according to claim 1, further comprising, prior to the step of applying lithium ions, the steps of:
applying a slurry of an anodic active carbonaceous material composition to an anodic collector;
drying the slurry; and
compression-molding the resulting article.

3. The method according to claim 1, wherein the step of applying lithium ions comprises applying lithium ions to a carbonaceous material in its production to thereby yield an anodic active carbonaceous material containing lithium ions.

4. A method for producing a rechargeable lithium battery, comprising the steps of:
applying lithium ions to a carbonaceous material in its production to thereby yield a carbonaceous material containing lithium ions;
mixing the carbonaceous material containing lithium ions with a carbonaceous material containing no lithium ions to yield an anodic active carbonaceous material doped with lithium ions in an amount corresponding to an irreversible capacity; and
forming an anode doped with lithium ions in an amount corresponding to the irreversible capacity using the lithium-doped anodic active carbonaceous material.

5. The method according to claim 4, further comprising:
supplying a gas of a carbon compound, a gas of an organic transition metal compound, and a gas containing fine particles of a transition metal to a tubular reactor, while controlling the temperature of the reactor, to thereby form the carbonaceous material; and
doping the formed carbonaceous material with lithium ions in an amount corresponding to an irreversible capacity in a tubular lithium-irradiator while controlling the temperature of the irradiator.

6. The method according to claim 5, wherein the tubular lithium-irradiator comprises a helical lithium ion source and an auxiliary electrode arranged at the center part of the helical lithium ion source, and the carbonaceous material is doped with lithium ions by the action of a voltage applied between the lithium ion source and the auxiliary electrode.

7. The method according to claim 5,
wherein the tubular reactor comprises an auxiliary electrode at the center part of the tubular reactor and a helical dielectric-associated electrode surrounding the auxiliary electrode, and the carbonaceous material is formed by the action of high-pressure plasma discharge generated between the dielectric-associated electrode and the auxiliary electrode;
wherein the tubular lithium-irradiator comprises an auxiliary electrode arranged at the center part of the tubular lithium-irradiator, a tungsten coil, and a lithium supply tube, and at least one selected from the group consisting of vaporized lithium, lithium fine particles and lithium multiple oxides such as lithium dichromate is supplied to the tungsten coil via the lithium supply tube to form lithium ions; and
wherein the formed lithium ions are applied to the formed carbonaceous material to thereby dope the carbonaceous material with lithium ions.

8. A rechargeable lithium battery comprising an anode produced by the method of of comprising the step of applying lithium ions to a carbonaceous material to thereby yield an anodic active carbonaceous material doped with lithium ions in an amount corresponding to an irreversible capacity.

9. A rechargeable lithium battery comprising an anode produced by the steps of applying lithium ions to a carbonaceous material in its production to thereby yield a carbonaceous material containing lithium ions; mixing the carbonaceous material containing lithium ions with a carbonaceous material containing no lithium ions to yield an anodic active carbonaceous material doped with lithium ions in an amount corresponding to an irreversible capacity; and forming an anode doped with lithium ions in an amount corresponding to the irreversible capacity using the lithium-doped anodic active carbonaceous material.
